(19) United States
(12) Patent Application Publication
(10) Pub. No.: US 2004/0254071 A1
(43) Pub. Date: Dec. 16, 2004

(54) Method for control of washcoat distribution along channels of a particulate filter substrate

(76) Inventors: Jiyang Yan, Broken Arrow, OK (US); Ming Wei, Broken Arrow, OK (US)

Correspondence Address: Vincent A. Cichosz, Esq., Delphi Technologies, Inc., Mail Code: 480-410-202, P.O. Box 5052, Troy, MI, 48007, US

(21) Appl. No.: 10/460,569

(22) Filed: Jun. 11, 2003

(51) Int. Cl. B01J 23/02

(52) U.S. Cl. 502/439

(57) ABSTRACT

Disclosed herein is a method of distributing a washcoat along channels of a particulate filter substrate, the method comprising: disposing a washcoat slurry comprising a catalytically active material within a channel of a particulate filter element such that a concentration of the catalytically active material varies anisotropically along the length of the channels. In one embodiment, a solids content of the washcoat slurry is selected to provide an anisotropic variation in the concentration of the catalytically active material. The washcoat slurry may be pushed a predetermined distance into the channels, the predetermined distance being less than or equal to the full length of the channels, and the pushing may be performed once. The solids content of the washcoat composition may be increased to provide an increase in a concentration of the catalytically active material proximate an end of the particulate filter substrate. Alternatively, the solids content of the washcoat composition may be decreased to increase the uniformity of in the distribution of the catalytically active material throughout a length of the particulate filter substrate.

### BACKGROUND

Federal and state requirements have mandated substantial reductions in carbon particulate matter (so called soot), hydrocarbons and carbon monoxide emission for internal combustion engines. Attempts at reducing such emissions, in particular attempts to reduce particulate matter emissions from diesel engines, include catalytic diesel particulate filters (DPF) in which a catalytically active material is disposed within a substrate in the particulate filter. The catalyst promotes removal (e.g., oxidation) of particulate matter and other byproducts of diesel fuel combustion in the exhaust gas stream.

Applying a catalytic material (also referred to herein as a washcoat) to the particulate filter substrate is one of the most promising technologies for effective removal (combustion) of trapped particulate matter. In general, better catalytic performance is achieved by increasing washcoat loading so as to increase the concentration of catalytically active material present. However, an increase in washcoat loading can result in an increase in flow restriction when exhaust gas flows through particulate filter. The increase in exhaust gas flow restriction results in an increase in exhaust line backpressure, which is detrimental to engine performance and fuel economy. In general, the lower the backpressure of the exhaust line, the better the engine performance and fuel economy will be. Accordingly, a need exists for a particulate filter that provides for reduction of particulate matter emissions in the exhaust gas while minimizing backpressure caused by the particulate filter.

### SUMMARY OF THE INVENTION

Disclosed herein is a method of distributing a washcoat along channels of a DPF substrate, the method comprising: dispersing a washcoat slurry comprising a catalytically active material within a channel of a particulate filter such that a concentration of the catalytically active material varies anisotropically along the length of the channels. In one embodiment, a solids content of the washcoat slurry is selected to provide an anisotropic variation in the concentration of the catalytically active material. The washcoat slurry may be forced to travel a predetermined distance into the channels, the predetermined distance being less than or equal to the full length of the channels, and the pushing may be performed once. The solids content of the washcoat composition may be increased to provide an increase in a concentration of the catalytically active material proximate an end of the particulate filter substrate. Alternatively, the solids content of the washcoat composition may be decreased to increase the uniformity of distribution of the catalytically active material throughout a length of the particulate filter substrate.

### FIGURES

FIG. 1 shows a cross-sectional view of a particulate filter including a catalytic particulate filter substrate, which is shown in partial cut-away view.

FIG. 2 shows a perspective view of an embodiment of the catalytic particulate filter substrate;

FIG. 3 shows an isoscan plot of a particulate filter substrate having washcoat evenly distributed, and a particulate filter substrate having washcoat biased toward one end; and

FIG. 4 shows the relative backpressure increase after washcoating of particulate filter with different washcoat distribution patterns.

### DETAILED DESCRIPTION

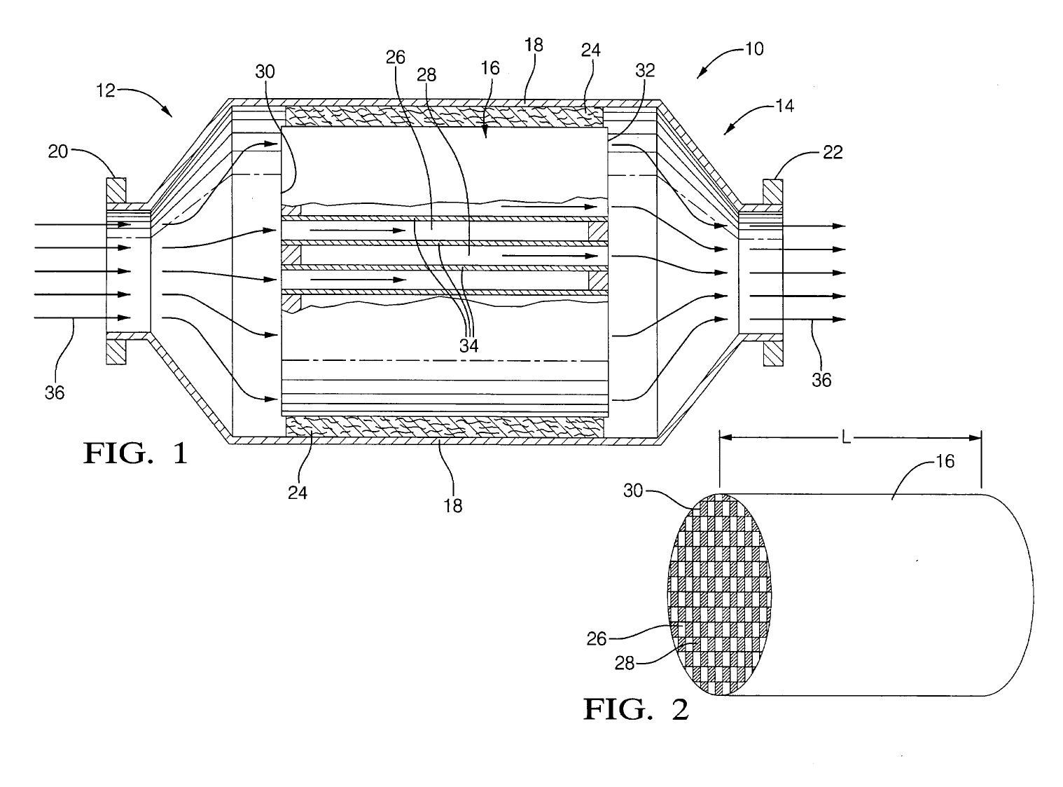

Referring to FIG. 1, a particulate filter 10 may be part of an exhaust gas emission control system in which an inlet 12 on the particulate filter 10 is in fluid communication with an exhaust manifold of an internal combustion engine (e.g., a diesel engine), and an outlet 14 on the filter 10 is in fluid communication with an exhaust gas destination, such as atmosphere. In addition, the system may comprise various other emission control devices including catalytic converters, evaporative emission devices, scrubbing devices, adsorbers/absorbers, non-thermal plasma reactors, mufflers, and the like, as well as combinations comprising at least one of the foregoing devices.

The particulate filter 10 comprises a particulate filter substrate 16 enclosed within a housing or canister 18. The canister 18 may have an input collar 20 connectable to the exhaust manifold or other components in the system such as a turbocharger, and an output collar 22 connectable to the tailpipe or other components in the system. Located between the particulate filter substrate 16 and the interior of the canister 18 is a retention or support material 24 that supports and protects the particulate filter substrate 16, and insulates the canister 18 from both the high exhaust gas temperatures and the exothermic catalytic reaction occurring within the particulate filter substrate 16.

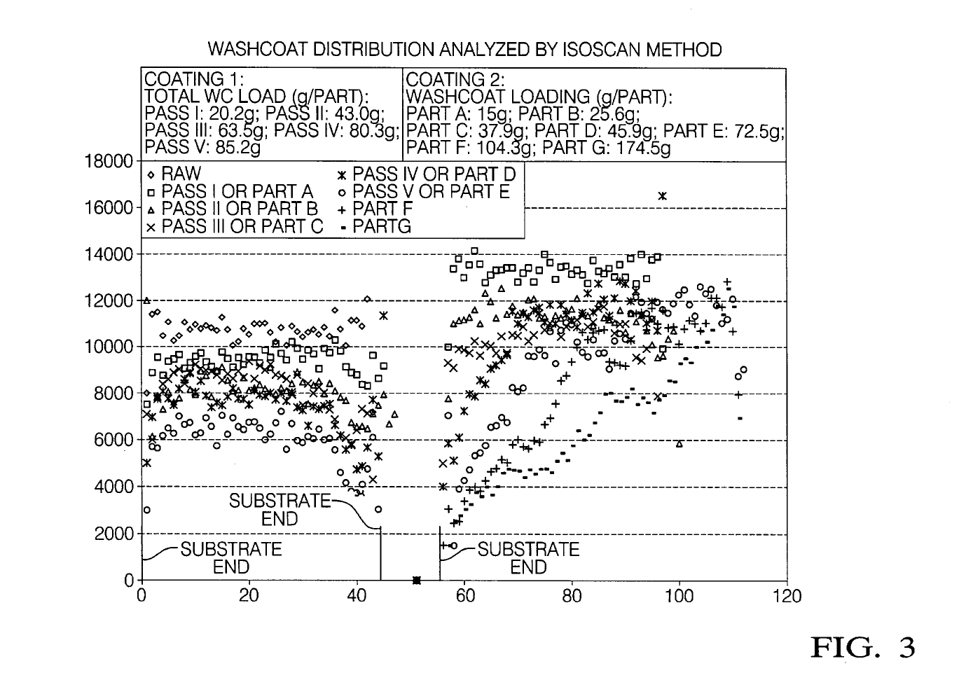

The particulate filter substrate 16, which is shown in a partial cut-away view, may comprise a gas permeable ceramic material having a honeycomb structure consisting of a plurality of channels, preferably parallel channels. The channels may be divided into alternating inlet channels 26 and outlet channels 28. The inlet channels 26 are open at an inlet end 30 of the particulate filter substrate 16 and preferably plugged at an outlet end 32 of the substrate 16. Conversely, outlet channels 28 are preferably plugged at the inlet end 30 and open at the outlet end 32. The inlet and outlet channels 26, 28 are formed and separated by thin porous longitudinal sidewalls 34, which permit exhaust gases 36 to pass from the inlet channels 26 to the outlet channels 28 along their length. As shown in FIG. 2, the particulate filter substrate 16 may be a generally cylindrical structure with a plurality of inlet and outlet channels 26, 28 disposed therein. The inlet and outlet channels 26, 28 may have a substantially rectangular cross-sectional shape. However, the channels 26, 28 may have any multi-sided or rounded shape, with substantially square, triangular, hexagonal, or octagonal or similar geometries. The dimensions of the inlet and outlet channels 26, 28 depend on various design considerations, including space limitations, projected washcoat loading, and end use requirements.

The particulate filter substrate 16 may comprise any material designed for use in the environment and which may remove particulate matter from a gaseous stream. Some possible materials include ceramics (e.g., extruded ceramics, such as Cordierite, aluminum oxide, aluminum phosphate and the like), metals (e.g., extruded, sintered metals. metal mesh materials), silicon nitrate and silicon carbide, and the like, and mixtures comprising at least one of the foregoing materials.

Dispersed on the sidewalls 34 forming the inlet and outlet channels 26, 28 are one or more washcoat compositions comprising one or more catalytically active materials. While the washcoat compositions are said to be dispersed “on” the sidewalls 34, it is also possible that at least a portion of the washcoat compositions will be located within the sidewalls 34. Thus, as used herein, a washcoat dispersed on the sidewalls includes washcoat dispersed on and/or in the sidewalls.

The washcoat compositions need not be present along the entire length of the channels 26, 28, and may be dispersed in one or both of the inlet and outlet channels 26, 28. For example, a washcoat may be coated throughout the length “L” of the inlet channel 26, or only through part of the length “L” near the inlet end 30. For certain application the washcoat may also be coated through the entire length “L”, or a portion of the length “L”, of the outlet channels 28. For certain application, washcoat may also be coated on a portion of the length “L”, of the inlet channels 26 and a portion of the length “L”, of the outlet channels 28. The choice of the locations, amount, and type of washcoat depend on the application of the particulate filter 10.

The catalytic material used in the washcoat composition may be any components capable of reducing the concentration of at least one component in the exhaust gas. Thus, the catalyst may comprise one or more catalytic materials. Possible catalyst materials include metals, such as barium, cesium, vanadium, molybdenum, niobium, tungsten platinum, palladium, rhodium, iridium, ruthenium, zirconium, yttrium, cerium, lanthanum, and the like, as well as oxides, alloys, and combinations comprising at least one of the foregoing catalyst materials, and other catalysts.

In operation, exhaust gas 36 generated by the internal combustion engine passes through the exhaust gas manifold into the inlet channels 26 of the particulate filter substrate 16. The exhaust gas passes through the sidewalls 34 into the outlet channels 28, and the porous sidewalls 34 permit the exhaust gas 36 to pass from the inlet channels 26 to the outlet channels 28 such that the inlet channels 26 collect particulate matter contained in the exhaust gas 36. The catalyst material dispersed on sidewalls 34 promotes removal (e.g., oxidation) of the particulate matter collected at inlet channel 26. From the outlet channels 28, the exhaust gas 36 flows toward the exhaust gas destination.

It has been discovered that backpressure caused by the particulate filter 10 can be adjusted using an anisotropic washcoat application throughout the length “L” of the inlet and/or outlet channels 26, 28. In other words, the loading (concentration) of catalytic material varies along the length “L” of the inlet and/or outlet channels 26, 28. The anisotropy need not be linear or uniform, and preferably only varies from one location (e.g., the inlet end 30) of the particulate filter substrate 16 to another location (e.g., the outlet end 32) of the particulate filter substrate 16.

The additional backpressure caused by washcoating the particulate filter substrate 16 is mainly determined by the thickness of the washcoat dispersed on substrate wall surface or in the substrate porous wall where exhaust gas is passing by. Thus, the backpressure of caused by the coated particulate filter substrate 16 may be controlled by selectively locating the washcoat in the particulate filter substrate 16. For example, to minimize exhaust gas backpressure, washcoat may be heavily applied in a portion of the substrate channel. This portion of the channel will have relatively high flow restriction due to the washcoat loading. When exhaust gas flows through the channel, it will tend to pass through another portion of the channel that does not contain washcoat or that contains relatively less washcoat, which results in less flow restriction. The anisotropy in the catalytic material concentration provides for an increase in catalytic loading without causing a substantial increase in backpressure, as compared to a uniform loading of the catalytic material dispersed throughout.

In general, the more catalytically active material that can be applied to the substrate, the better activity the converter can achieve. In addition, selectively locating the washcoat in one portion of the substrate may also help to improve the catalytic activity of particulate matter reduction. For example, temperature is critical for ignition of particulate matter combustion, regardless of whether it is performed catalytically or non-catalytically. In the catalytic converter design of FIG. 1, inlet exhaust gas is always hotter than outlet exhaust gas due to the heat loss to the converter. Locating the catalyst at inlet end 30 will allow the catalyst to heat up faster and will allow for the faster catalytic ignition of soot. Thus, controlling the washcoat location is beneficial to both lowering backpressure of converter and improving particulate matter reduction performance.

It has been determined that the location of the washcoat within the channels can be controlled by adjusting the solid content of the washcoat slurry and applying the washcoat slurry in a single-pass. Applying a washcoat slurry with a higher solid content yields a washcoat deposited (loaded) in the channels proximate the end of the particulate filter substrate 16 through which the washcoat slurry was forced into, while applying a washcoat with a lower solid content yields a more uniform washcoat loading throughout the distance that the washcoat slurry was pushed into the channels. For example, if higher washcoat loading at the inlet end of the inlet channels is desired, a washcoat slurry having a higher solid content (e.g., a solid content in the range of between about 5-50%) would be forced to travel a predetermined distance (e.g., 30% of L, 50% of L, 70% of L, 100% of L) into the inlet channels via the inlet end of the filter substrate. After the washcoat slurry is forced into the channels, excess washcoat slurry is removed from the channels by using a vacuum, air blowing, or the like. Because a washcoat slurry having a higher solid content is used, the washcoat will be more heavily loaded toward the inlet end, with the washcoat loading extending no further than the predetermined distance. Higher washcoat loading at the outlet end of the outlet channels can be similarly obtained by pushing a washcoat slurry having the higher solid content into the outlet channels via the outlet end of the filter substrate.

If a more uniform washcoat loading in the inlet channels is desired, a washcoat slurry having a lower solid content (e.g., a solid content in the range of between about 1-10%) would be pushed a predetermined distance (e.g., 30% of L, 50% of L, 70% of L, 100% of L) into the inlet channels via the inlet end of the filter substrate. After the washcoat slurry is forced into the channels, excess washcoat slurry is removed from the channels by using a vacuum, air blowing, or the like. Because a washcoat slurry having a lower solid content is used, the washcoat will be more uniformly attached to the substrate wall and uniformly loaded throughout the predetermined distance, with the washcoat loading extending no further than the predetermined distance. Uniform washcoat loading in the outlet channels can be similarly obtained by pushing a washcoat slurry having the lower solid content into the outlet channels via the outlet end of the filter substrate.

By controlling the solid content of the washcoat slurry and the distance that the slurry traveled in the channels, the position of the washcoat along the length “L” of the inlet and/or outlet channels 26, 28 in the particulate filter substrate 16 can be controlled. In this manner, the washcoat loading may be biased towards either the inlet end 30 or the outlet end 32 of either the inlet channels 26, the outlet channels 28, or both the inlet and outlet channels of the particulate filter substrate 16.

After the washcoat slurry is applied to the substrate 16 and the excess slurry is removed, the coated part is calcined at high temperature (e.g. >450° C.) in oven to decompose any organic component from raw material, evaporate water, and fix the washcoat to the substrate 16.

### EXAMPLES

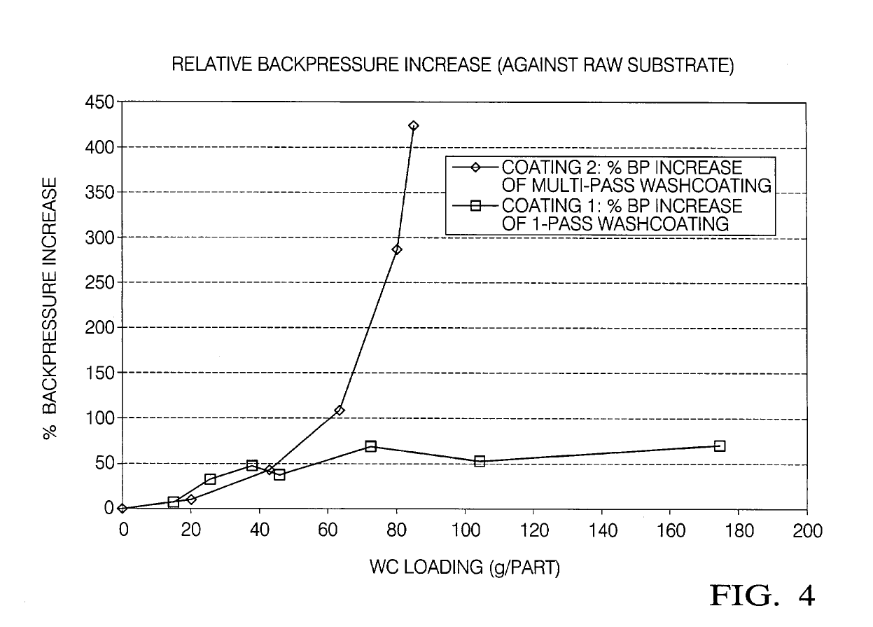

### Comparative Example 1 (Coating 1 of FIGS. 3 and 4)

In a comparative example, one particulate filter substrate was washcoated using five passes (applications) of a single washcoat slurry. In each pass, the washcoat slurry was fully pushed into the channels of the filter substrate via one end. The resulting washcoat loading after each of the five passes were:

Pass I—20.2 grams/part

Pass II—43.0 grams/part

Pass III—63.5 grams/part

Pass IV—80.3 grams/part

Pass V—85.2 grams/part

Referring to FIG. 3, an isoscan plot of the particulate filter of the comparative example is shown as Coating 1. As can be seen by the isoscan plot of Coating 1, by applying multiple coating passes, washcoat loading on the substrate increases with each pass while distribution of the washcoat loading is substantially even along the length of the filter substrate.

### Example 1 (Coating 2 of FIGS. 3 and 4)

Seven particulate filter substrates were each washcoated using an embodiment of the method of the present invention. For each filter substrate, a washcoat slurry having a predetermined solid content was prepared and the washcoat slurry was applied in a single-pass application. The washcoat slurry used in Example 1 was the same as the slurry used in Comparative Example 1, only with higher solids content. The solids content in the washcoat slurry was increased for each filter substrate from A to G. The single-pass application included pushing the washcoat slurry the entire length of the channels (100% of L) from one side of the filter substrate and clearing the excess washcoat slurry from the channels. The resulting washcoat loading for each washcoat pass was as follows:

Particulate Filter Substrate (part) A—15 grams/part

Particulate Filter Substrate (part) B—25.6 grams/part

Particulate Filter Substrate (part) C—37.9 grams/part

Particulate Filter Substrate (part) D—45.9 grams/part

Particulate Filter Substrate (part) E—72.5 grams/part

Particulate Filter Substrate (part) F—104.3 grams/part

Particulate Filter Substrate (part) G—174.5 grams/part

As can be seen, coating with a higher solid content slurry yields a higher washcoat loading of the particulate filter. Referring to FIG. 3, isoscan plots of the particulate filters of this example are shown as Coating 2. As can be seen by the isoscan plots of Coating 2, as the solid content of the washcoat slurry is increased, the washcoat loading becomes more anisotropic along the length of the particulate filter, with more of the washcoat loading being disposed towards one end of the particulate filter. With a washcoat having a lower solid content, the washcoat distribution is more homogeneous throughout the length of the particulate filter.

Referring to FIG. 4, the backpressure increase for Coating 1 and Coating 2, as a percent increase over an uncoated (raw) substrate, are shown as functions of washcoat loading on the DPF substrate. As shown for Coating 1, the comparative example, backpressure increases exponentially at washcoat loading higher than 40 grams/part. In comparison, the single-pass method of the present invention, as embodied in Coating 2, provides only a mild backpressure increase for increased amounts of washcoat loading, even for washcoat loading as high as 175 grams/part.

Described herein is a method for controlling the washcoat distribution along the channels of a coated particulate filter substrate. The method allows for anisotropically coating a particulate filter substrate, which provides for an uneven distribution of catalytically active material within the channels of a particulate filter substrate. By controlling the location of the washcoat in the particulate filter substrate, the backpressure caused by the coated particulate filter substrate and the flow of the exhaust gasses through various portions of the filter substrate may be controlled.

While the invention has been described with reference to an exemplary embodiment, it will be understood by those skilled in the art that various changes may be made and equivalents may be substituted for substrates thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1) A method for transparently linking keywords in a document, displayed in a document viewer on a display monitor attached to an end-user computer system, to information on a remote information retrieval web site providing keyword-based information lookup service from a keyword-to-information mapping database comprising the steps:
a) Specifying a hot key
b) Requesting a keyword lookup by selecting a keyword displayed in the said document viewer using an input device in coordination with the application of the said hot key
c) Retrieving the said keyword selected in b) from the display buffer of the said document viewer identified by the said input device
d) Requesting the said lookup service on the said remote information retrieval web site to retrieve information associating with the said keyword
e) Receiving the information resulted in step e)
f) Properly handling the said retrieved information by the said document viewer or a third-party program

2) A method in claim 1) further comprising a step for interactively prompting the user either to confirm the said selected keyword retrieved in step 1.c) or input an alternate keyword.

3) A method in claim 2) wherein the said lookup server further performs processing of the said retrieved information in according to specific-application requirements and sending the data resulted from the said processing in response to the said retrieval request in step 1.d).

4) A method in claim 1) to 3) further comprising a plurality of said remote information retrieval web sites and a step for automatically repeating the steps 1.d) to 1.f) for retrieving information associating with the said selected keyword from each of the said remote information retrieval web sites and combining the said retrieved information into an integrated result set in responding to a said keyword lookup request in step 1.b).

5) A method in claim 4) further comprising a step for interactively prompting the user to select one or more said remote information retrieval web sites for information retrieval prior to retrieval request in step 1.d).

6) A method in claim 4) to 5), wherein a plurality of distinct said hot keys are specified on one or more input devices attached to the said end-user computer system and each said hot key is mapped to one or more said remote information retrieval web sites, further comprising a step for automatically repeating the steps 1.d) to 1.f) for retrieving information associating with the said selected keyword from the said mapped remote information retrieval web sites and combining the retrieved information into an integrated result set in responding to the said keyword lookup request in step 1.b).

7) A method in claim 6) further comprising a step for interactively prompting the user to select one or more said mapped remote information retrieval web sites for information retrieval.

8) A method in claim 6) to 7), wherein the said information in the said keyword-information mapping database is categorized and each said hot key is further associated with one or more categories of information, with step 1.d) further conveying the categories associated with a said applied hot key to the said remote information retrieval web site(s) for use in filtering the said retrieval result for information associating with the said selected keyword and the said categories only.

9) A method in claim 1) to 8), wherein the said information resulted in step 1.f) is a reference to a web object hosted on another web site, further comprising a step for automatically retrieving the said web object in responding to a said keyword lookup request in step 1.b).

10) A method in claim 1) to 8), wherein the said information resulted in step 1.f) is a plurality of references to web objects hosted on one or more web sites, further comprising a step for automatically repeating the steps 1.d) to 1.f) for retrieving the said referenced web objects and combining the retrieved information into an integrated result set in responding to a said keyword lookup request in step 1.b).

11) A method in claim 10), further comprising a step for interactively selecting one or more said web objects for retrieval.

12) A method in claim 1) to 11) wherein keywords in the said document and subsequent retrieved textual information intended for display are tagged with pre-determined display attribute tags causing the said keywords to be distinctly displayed in the said document viewer as selectable keywords.

13) A method in claim 1) to 11) wherein the said keywords in the display buffer of the said document viewer are marked with a pre-determined display attribute causing the said keywords to be distinctly displayed in the said document viewer as selectable keywords.

14) A method for hyper-linking a hypertext or hyperimage in a web page displayed in the content display area of a web browser to a web object on a web site using a keyword comprising the steps:
a) Storing the said keyword in association with a reference link to the said web object in a keyword-to-web object reference (URL) mapping database hosted on a web site executing a keyword lookup server operating on the said keyword-to-web object reference mapping database
b) Storing the said keyword in the said hyperlink associated with the said hypertext or hyperimage in the said web page in place of a web object reference
c) Displaying the said web page in the content display area of the said web browser
d) Requesting the retrieval of the said web object by selecting the said hypertext or hyperimage in display using an input device
e) Retrieving the said keyword in the said hyperlink associated with the said hypertext or hyperimage
f) Contacting the said keyword lookup server and communicating the said keyword to the said keyword lookup server for resolving the said keyword into the associated web object reference
g) Further retrieving the said web object from the said web site referenced by the said web object reference
h) Processing the said web object as a commercial web browser normally would

15) A method in claim 14), wherein the said keyword resolution in step 14.g) results a plurality of web object references, further comprising a step for automatically repeating the step 14.h) for retrieving the referenced web objects and combining the said retrieved web objects into in integrated result set in responding to the said web object retrieval request.

16) A method in claim 15) further comprising a step for interactively prompting the user to select one or more said web object references for retrieval.

17) A method in claim 14) to 16) wherein the said keyword-mapped object is a web object instead of the said web object reference and, as a result, the data resulted in step 14.f) is a web object and, therefore, step 14.g) is skipped.

18) A method in claim 14) to 16) wherein the said keyword-mapped object can be either a web object reference or a web object and step 14.g) is applied only if the data retrieved in step 1.f) is a web object reference.

19) A method in claim 14) to 18) further including a mean in a said web page for dynamically specifying a keyword lookup server for use in step 14.f) in resolving keyword hyperlinks immediately followed the said mean in the said web page.

20) A method in claim 14) to 19) further including a keyword lookup server specification in the said keyword hyperlink for use in step 14.f) in resolving the said keyword hyperlink overriding the said keyword lookup server specification in claim 19).

21) A method in claim 14) to 20) wherein the said keyword-to-information mapping database is further categorized, a said keyword hyperlink further specifies one or more category identifiers with which the said keyword hyperlink is associated and step 14.f) further communicates the said category identifiers to the said keyword lookup server for filtering the said lookup result for objects associating with a said keyword and the said categories only.

22) A method in claim 14) to 21) further comprising a step for automatically hyperlinking keywords and image references in a said web page to associated information stored in the said keyword-to-information mapping database.

23) A system for transparently linking keywords displayed in a document viewer to information on a remote information retrieval web site comprising the said remote information retrieval web site and a plurality of end-user computer systems coupled to the said remote information retrieval web site over a computer network; the said remote information retrieval web site maintaining a keyword-to-information mapping database and executing a keyword lookup server operating on the said mapping database for providing a keyword-based information lookup service; each of the said end-user computer systems at least executing an access agent and a document viewer; the said information can be a web object, a web object reference or any types of data that the said document viewer or a third-party program can recognize and process and the said access agent further:
a) Maintains a hot key
b) Installs an input device interceptor module for monitoring input events from an input device for the said hot key
c) Uses a method in claim 1) to 3) for retrieving information associated with a keyword displayed in the said document viewer and selected by the user in coordination with the application of the said hot key

24) A system in claim 23) wherein each of the said end-user computer systems further executes a commercial web browser and the said access agent uses the said web browser to retrieve the said information by communicating the retrieval protocol, said remote information retrieval system, the said keyword lookup server and the said user-selected keyword to the said web browser for retrieving and handling information associating with the said user-selected keyword.

25) A system in claim 23) wherein each of the said end-user computer systems further executes a commercial web browser capable of retrieving information associating with a keyword from the said remote information retrieval system and the said access agent uses the said web browser to retrieve the said information by communicating only the said user-selected keyword to the said web browser for retrieving and handling information associating with the said user-selected keyword instead.

26) A system in claim 23) to 25) wherein the said document viewer is a web browser and the said access agent communicates the retrieval protocol, the said remote information retrieval system, the said lookup server and the said user-selected keyword to the said web browser for retrieving and handling information relating to the said keyword instead.

27) A system in claim 23) to 25) wherein the said document viewer is a web browser capable of retrieving information associating with a keyword from the said remote information retrieval system and the said access agent communicates only the said user-selected keyword to the said web browser for retrieving and handling information associating with the said keyword instead.

28) A system in claim 23) further comprising a plurality of said remote information retrieval web sites coupled to the said end-user systems over a computer network and the said access agent further performing a method in claim 4) to 5) for information retrieval.

29) A system in claim 23) and 28) wherein the said access agent further maintains a plurality of the said hot keys, each is mapped to one or more said information retrieval web sites, and the said access agent further performing a method in claim 6) to 7) for information retrieval.

30) A system in claim 29) wherein the said keyword-to-information mapping database is categorized, each of the said hot keys is associated with one or more said categories and the said access agent further uses the method in claim 8) for information retrieval.

31) A system in claim 23) to 30) wherein the said information can be references to web objects hosted on the said remote web sites, further comprising a plurality of remote web sites coupled to the said end-user systems and the said remote information retrieval systems over a computer network and the said lookup server further incorporates the said methods in claim 9) to 11) for generating a response to a keyword lookup request from a said access agent.

32) A system in claim 31) wherein the said access agent further incorporates the methods in claim 9) to 11) for handling of said web object reference(s) on the end-user computer system instead of by the said lookup server on the said remote information retrieval system.

33) A system in claim 23) to 32) wherein the said retrieved information is textual information intended for display and the said lookup server automatically tags keywords in the said retrieved information with a pre-configured display attribute prior to responding to the said keyword lookup request.

34) A system in claim 23) to 32) wherein the said retrieved information is textual information intended for display and the said access agent further:
a) maintains a local list of keywords retrieved from the said keyword-to-information mapping database on the said remote information web site(s)
b) periodically updates the said local keyword list from the said keyword-to-information database and
c) automatically marks the said keywords displayed in the display buffer of the said document viewer with a pre-configure special display attribute.

35) A system in claim 23), 28), 29), 30), 32) and 34) wherein the said access agent is a commercial web browser further incorporating the method(s) included in the said access agent as described in those claims.

36) A system in claim 24) to 27) wherein the said web browser further includes the methods in claim 4) to 5).

37) A system in claim 24) to 27), 36) wherein the said web browser further includes the methods in claim 6) to 7).

38) A system in claim 24) to 27), 36) to 37) wherein the said web browser further includes the method in claim 8).

39) A system in claim 24) to 27), 36) to 38) wherein the said web browser further includes the methods in claim 9) to 11).

40) A system in claim 24) to 27), 36) to 39) wherein the said web browser further includes the functionality of the said access agent as described in claim 37).

41) A system in claim 23) to 40) further comprising a central information retrieval web site coupled to the said information retrieval web sites and the said end-user computer systems over a computer network, wherein the said central information retrieval web site further:
a) maintains a registration database of which records at least storing the contact information of a said remote information retrieval web site, associated authentication information, last successful upload timestamp
b) executes a registration server for registering the said remote information retrieval web sites, assigning a unique logon and an associated password to each of the said registered remote information retrieval web sites and recording the said registration data in the said registration database in association with the said registered remote information retrieval web sites
c) executes an upload server for receiving uploads of keyword-to-information mapping entries from the said remote information retrieval web sites and optionally authenticate the said remote information retrieval web sites prior to granting upload privilege using the said authentication data stored in the said registration database.
And each of the said remote information retrieval web site further:
d) Differentially uploads the keyword-to-information mapping database on the said information retrieval web site to the said central information retrieval web site on periodic and/or on demand basis
e) Redirects the said access agent to retrieve information from the said central information retrieval web site if the said information retrieval web site fails to provide such information.

42) A system in claim 41) wherein only selected entries of the said keyword-to-information mapping database on each said information retrieval web site are qualified for upload to the said central keyword-to-information mapping database.

43) A system in claim 41) to 42) wherein:
a) the said keyword-to-information databases on the said remote and central information retrieval web sites are further categorized
b) the said remote information retrieval web site registration record further includes a field for storing one or more categories of which information will be uploaded and
c) only entries in registered categories of the said keyword-to-information mapping database on each said remote information retrieval web site are qualified for upload to the said central keyword-to-information mapping database.

44) A system in claim 41) to 43) wherein the said uploaded keyword-to-information entries are temporarily stored in a temporary keyword-to-information database in association with the originating information retrieval web site, further comprising a review and approval procedure executed by a human operator or an automated process for qualifying the said uploaded entries for importing into the said central keyword-to-information mapping database.

45) A system in claim 41) to 44) wherein a said remote information retrieval web site uploads only the web object reference to information in the said keyword-to-information mapping entries instead of the said information in the event a said information is a web object.

46) A system in claim 41) to 45), instead of executing the said upload server for uploading differential updates of the said data, the said central information retrieval web site executes an update retrieval program for periodically or on-demand retrieving the said data from each of the said remote information retrieval systems registered in the said registration database.

47) A system in claim 41) to 46) wherein each of the said central and remote information retrieval web sites further installs a digital certificate and establishes an secure SSL session for authenticating the communicating party and securing the said update data against tampering and privacy violation.
